(19) United States
(12) Patent Application Publication
(10) Pub. No.: US 2002/0179472 A1
(43) Pub. Date: Dec. 5, 2002

(54) Tool box having an upright standing portion

(76) Inventor: Hsiu-Yueh Lee, Taichung (TW)

Correspondence Address: Mr. Phillip LIU, 6980, Whiteoak Dr., Richmond, BC, V7E 4Z9, CA

(21) Appl. No.: 09/867,368

(22) Filed: May 30, 2001

(51) Int. Cl. B65D 85/28; F21V 33/00

(52) U.S. Cl. 206/373; 362/154

(57) ABSTRACT

A tool box includes a base having a first part and a second part which is pivotally connected between the first part and an extension portion. Each of the first part and the second part has a plurality of recesses defined therein for receiving tools therein. A triangular connection member is pivotally connected between the first part and a cover. A side of the triangular connection member has two bosses and the first part has two recesses so that the first part may stand upright by engaging the bosses with the recesses.

### FIELD OF THE INVENTION

The present invention relates to a tool box having a triangular connection member connected between two parts and one of the two parts is able stand upright.

### BACKGROUND OF THE INVENTION

A conventional tool box generally has a base and a cover which is pivotally connected to the base. Each of the base and the cover has a plurality of recesses so as to receive tools therein. However, if the tool box is used in a narrow area which does not allow the base and the cover to be put in open status, the user is difficult to hold the cover to choose tools that the user needs.

The present invention intends to provide a tool box which has a triangular connection member with its flat bottom standing on a surface and a part pivotally connected to the connection member can be held an upright position by engaging bosses of the connection member with recesses in the part.

### SUMMARY OF THE INVENTION

In accordance with one aspect of the present invention, there is provided a tool box and comprises a triangular connection member pivotally connected between a base and a cover. The connection member has a flat bottom which stands on a surface and the base is pivoted and maintained on an upright position by engaging bosses on the connection member with recesses in the base.

The primary object of the present invention is to provide a tool box that has a base is able to be maintained on an upright position.

These and further objects, features and advantages of the present invention will become more obvious from the following description when taken in connection with the accompanying drawings which show, for purposes of illustration only, an embodiment in accordance with the present invention.

### BRIEF DESCRIPTION OF THE DRAWINGS

FIG. 1 is a perspective view of the tool box in accordance with the present invention;

FIG. 2 is an exploded view of the tool box and the light means in accordance with the present invention;

FIG. 3 is an illustrative view to show that the first engaging member on the base is engaged with the second engaging member on the cover;

FIG. 4 is a perspective view to show the tool box in accordance with the present invention stands on the base of the triangular connection member, and

FIG. 5 is a cross-sectional view to show that the bosses on the connection member are engaged with the notches in the first part of the base.

### DETAILED DESCRIPTION OF THE PREFERRED EMBODIMENT

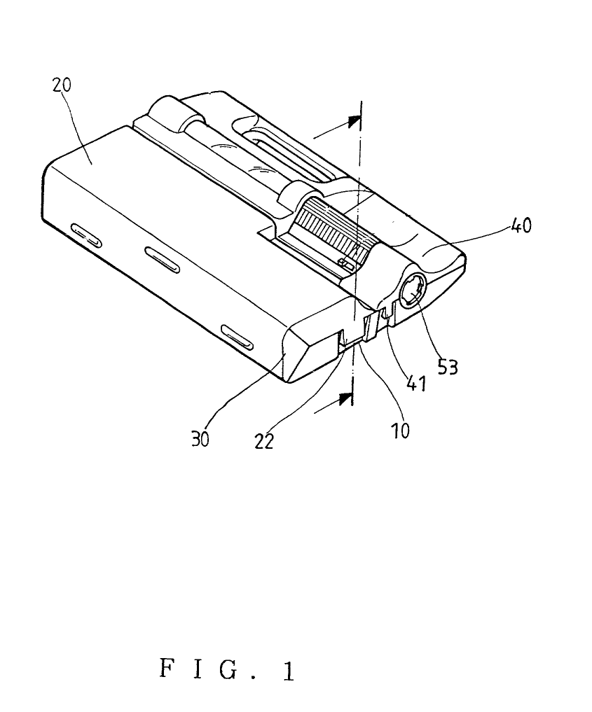

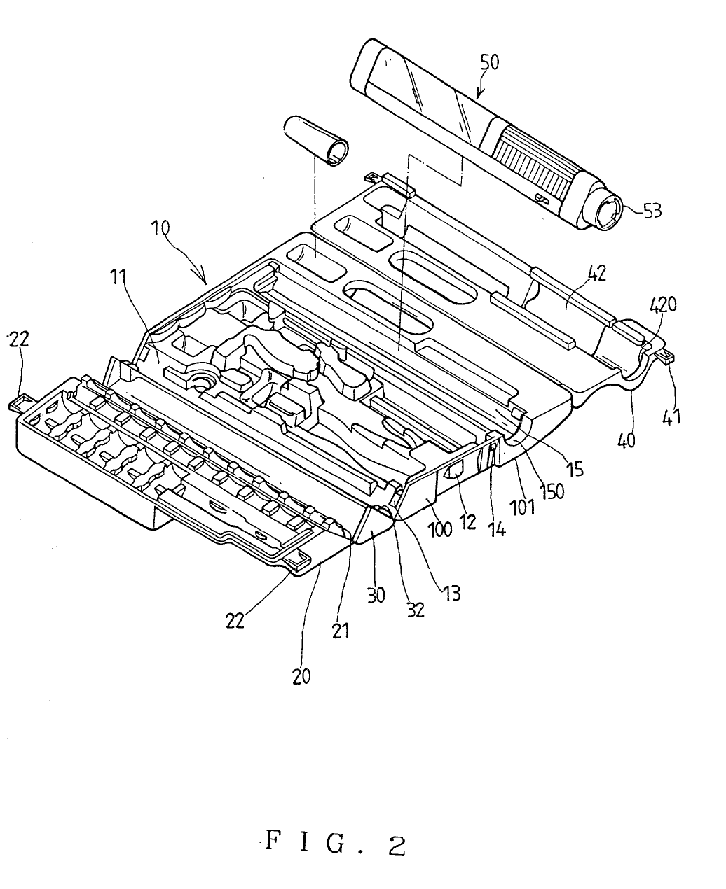

Referring to FIGS. 1 and 2, the tool box in accordance with the present invention comprises a base 10 having a first part 100 and a second part 101 which is pivotally connected to a first side of the first part 100. Each of the first part 100 and the second part 101 has a plurality of recesses defined therein for receiving tools. A triangular connection member 30 has a flat bottom and a first side and a second side. The first side of the connection member 30 is pivotally connected to a lower end of a second side of the first part 100, wherein the second side of the first part 100 is an inclined side 11 and two notches 13 are defined in the inclined side 11. A cover 20 has an inclined side 21 pivotally connected to a second side of the connection member 30. The flat bottom of the triangular connection member 30 can be put on a desk surface and two bosses 32 extend from the first side of the connection member 30. An extension portion 40 is pivotally connected to the second part 101.

The inclined side 11 of the first part 100 is able to be engaged with the first side of the connection member 30, and the inclined side 21 of the cover 20 is able to engage with the second side of the connection member 30 when the cover 20 is mounted onto the first part 100 as shown in FIG. 1.

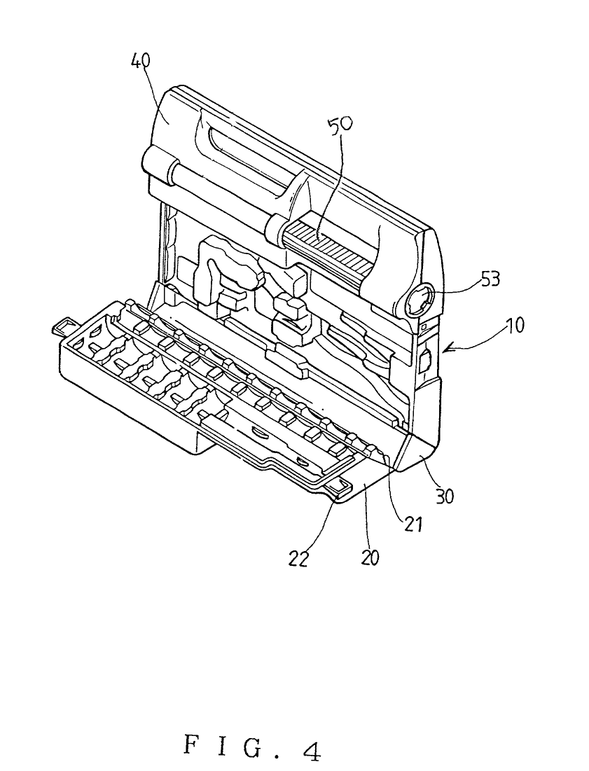

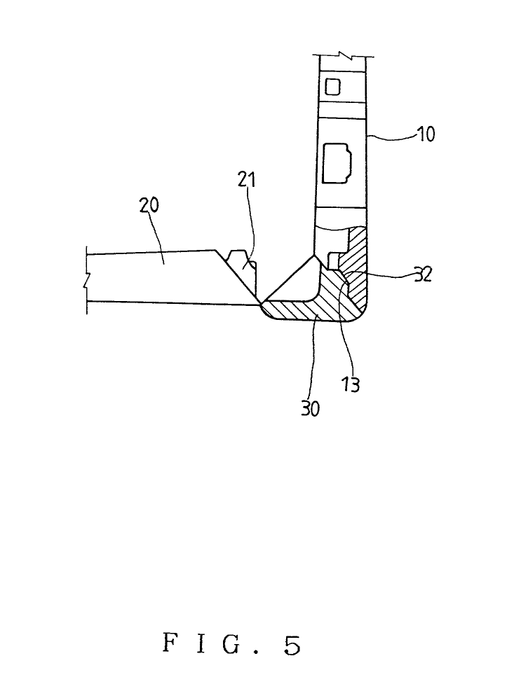

Referring to FIGS. 4 and 5, when pivoting the base 10 to an upright position, the inclined side 11 of the first part 10 engages with the first side of the connection member 30, and the two bosses 32 are received in the two notches 13. The base 10 is then maintained at its upright position.

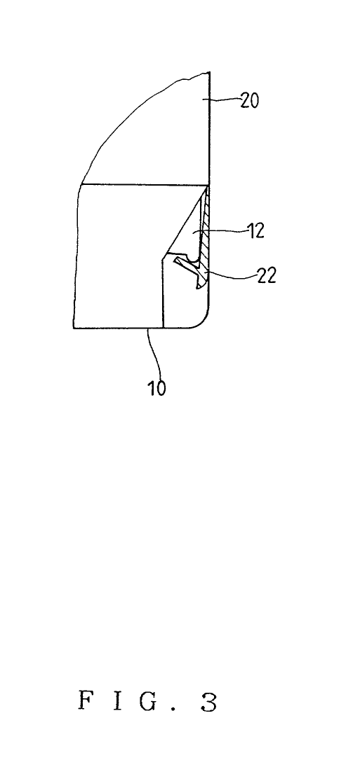

The first part 100 has a first engaging member 12 on each one of two ends thereof and the cover 20 has a second engaging member 22 connected to each one of two ends thereof so that the first engaging members 12 are engaged with the second engaging members 22 as shown in FIG. 3 when the cover 20 is mounted to the first part 100.

The extension portion 40 has a first long recess 42 defined therein and the second part 101 has a second long recess 15 defined therein. The extension portion 40 has a semi-circular recess 420 defined in one of two ends thereof, and the semi-circular recess 420 communicates with the first long recess 42. The second part 101 has a semi-circular recess 150 defined in one of two ends thereof, and the semicircular recess 150 communicates with the second long recess 15. A light device 50 is received in the first long recess 42 and the second long recess 15 when the extension portion 40 is mounted to the second part 101. The light device 50 has a tubular head 53 which extends through the two semi-circular recesses 420, 150 when the extension portion 40 is mounted with the second part 101.

The extension portion 40 has two third engaging members 41 connected to two ends of the extension portion 40, and the second part 101 has two fourth engaging members 14 connected to two ends of the second part 101. The third engaging members 41 are engaged with the fourth engaging members 14 when the extension portion 41 are mounted to the second part 101.

While we have shown and described the embodiment in accordance with the present invention, it should be clear to those skilled in the art that further embodiments may be made without departing from the scope of the present invention.

What is claimed is:

1. A tool box comprising:
a base having a first part and a second part which is pivotally connected to a first side of said first part, each of said first part and said second part having a plurality of recesses defined therein, a second side of said first part being an inclined side which has two notches defined therein;
a connection member having a flat bottom, a first side and a second side, said first side of said connection member pivotally connected to a lower end of said inclined side and having two bosses extending therefrom so that said two bosses are received in said two notches when said inclined side of said first part engages with said first side of said connection member, and
a cover having an inclined side which is pivotally connected to said second side of said connection member, said inclined side engaging with said second side of said connection member when said cover is pivoted and mounted onto said first part.

2. The tool box as claimed in claim 1 further comprising an extension portion pivotally connected to said second part and a light device received in said extension portion.

3. The tool box as claimed in claim 1, wherein said first part has a first engaging member on each one of two ends thereof and said cover has a second engaging member connected to each one of two ends thereof, said first engaging members engaged with said second engaging members.

4. The tool box as claimed in claim 2, wherein said extension portion has a first long recess defined therein and said second part has a second long recess defined therein, said light device received in said first long recess and said second long recess when said extension portion is mounted to said second part.

5. The tool box as claimed in claim 4, wherein said extension portion has a semi-circular recess defined in one of two ends thereof and said semi-circular recess communicating with said first long recess, said second part having a semi-circular recess defined in one of two ends thereof and said semi-circular recess communicating with said second long recess, said light device having a tubular head which extends through said two semi-circular recesses when said extension portion is mounted with said second part.

6. The tool box as claimed in claim 2, wherein said extension portion has two third engaging members connected to two ends of said extension portion, said second part having two fourth engaging members connected to two ends of said second part, said third engaging members engaged with said fourth engaging members when said extension portion are mounted to said second part.
